(19) United States
(12) Patent Application Publication
(10) Pub. No.: US 2024/0091911 A1
(43) Pub. Date: Mar. 21, 2024

(54) HIDDEN TOOL FOR ELECTRONIC DEVICE HOLDER

(71) Applicant: OXTI Pte Ltd, Singapore (SG)

(72) Inventor: Chih-Feng Ho, Singapore (SG)

(21) Appl. No.: 17/945,107

(22) Filed: Sep. 15, 2022

(51) Int. Cl. B25B 13/48; B25B 15/00

(52) U.S. Cl. CPC B25B 13/48; B25B 15/004

(57) ABSTRACT

A hidden tool for an electronic device holder includes: a holder; a main body, in connection with the holder, and provided with an adjusting portion; and a side plate, placed on one side of the main body, and provided with a tool turning portion complementary to the adjusting portion. With the adjusting portion and side plate inside the main body, the corresponding tool can be quickly obtained when the torque of holder needs to be adjusted, and the tool can be placed on the main body through the side plate, allowing a user to place the side plate back to the main body after the tool is used, so that the tool can be quickly obtained when needed to use next time and both the tool and adjusting portion can be hidden, thereby having a safe effect.

### (a) TECHNICAL FIELD OF THE INVENTION

The present invention relates to a hidden tool for an electronic device holder, and more particularly to a hidden tool for an electronic device holder that can hide an adjusting portion to have a safe effect, where the tool can be got to adjust the device and the tool can be hidden.

### (b) DESCRIPTION OF THE PRIOR ART

Taiwan Patent No. M602320, as FIG. 1 of the patent shows, discloses a device using installing seat allowing a computer screen to be installed thereon. However, it is not equipped with the corresponding tool, such that consumers need to purchase a corresponding tool from the market upon maintenance or installation, and a space must further be found to place the tool thereafter. In addition, most people will throw the tool everywhere, which causes the tool not to be found quickly when it needs to be used next time, and even not to be found, which needs to purchase it again.

### SUMMARY OF THE INVENTION

To overcome the above disadvantages of the prior arts that are usually not equipped with a corresponding tool, and even if equipped the tool, it is not provided with any space for the placement of the detached tool, such that when the tool needs to be used, the tool cannot be quickly obtained. Therefore, an object of the present invention is to provide a hidden tool for an electronic device holder, capable of quickly obtaining the tool when needed to use, and capable of having a place for the placement of the tool after use, thereby both the tool and an adjusting portion can be hidden.

To achieve the above object, the present invention proposes a hidden tool for an electronic device holder, including: a holder; a main body, in connection with the holder, and provided with an adjusting portion; and a side plate, placed on one side of the main body, and provided with a tool turning portion complementary to the adjusting portion.

With the adjusting portion and side plate inside the main body, the corresponding tool can be quickly obtained when the torque of holder needs to be adjusted, and the tool can be placed on the main body through the side plate, allowing a user to place the side plate back to the main body after the tool is used, so that the tool can be quickly obtained when needed to use next time and both the tool and adjusting portion can be hidden, thereby having a safe effect.

### BRIEF DESCRIPTION OF THE DRAWINGS

FIG. 1 is a perspective view of the present invention;

FIG. 2 is an exploded view of the present invention;

FIG. 3 is a perspective view of the present invention, where a main body and a side plate separated therefrom are shown;

FIG. 4 is a perspective view of the back surface of the side plate of the present invention;

FIG. 5 is partly cross-sectional view of the present invention, where a tool turning portion is concave;

FIG. 6 is partly cross-sectional view of the present invention, where a tool turning portion is convex;

FIG. 7 is a perspective view of the present invention in an adjustment state;

FIG. 8 is a partly cross-sectional view of the present invention, where the side plate is adsorbed on one side of the main body; and

FIG. 9 is a partly schematic view of the present invention, where the side plate is embedded in the main body.

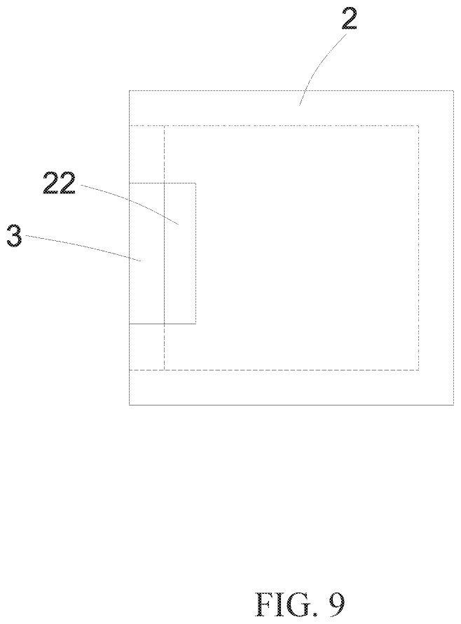

### DETAILED DESCRIPTION OF THE PREFERRED EMBODIMENTS

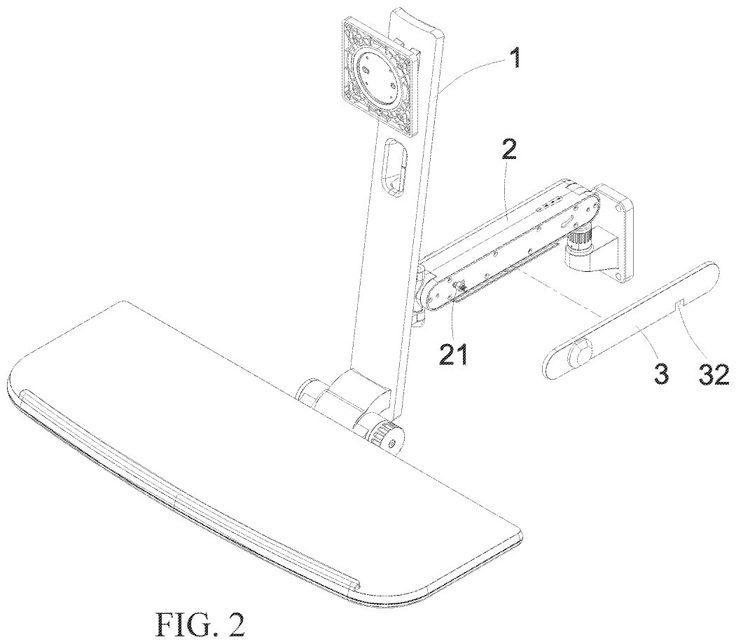

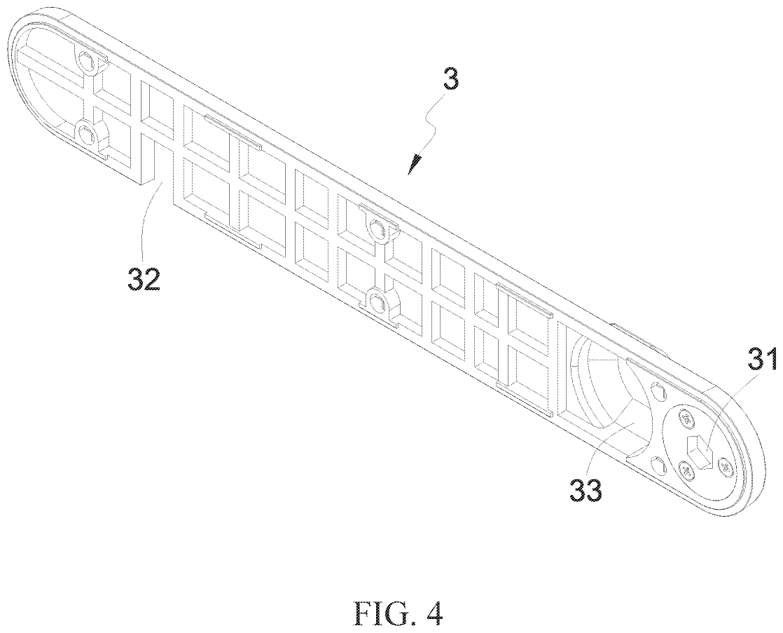

Referring to FIGS. 2 and 4, a hidden tool for an electronic device holder of the present invention includes a holder 1, main body 2, and side plate 3.

The holder 1 and main body 2 in connection with each other, where the main body 2 is provided with an adjusting portion 21 for the torque adjustment of the holder 1. The side plate 3 is configured on one side of the main body 2 and provided with a tool turning portion 31, which may be a wrench, clamp arm, screwdriver or hex wrench. Furthermore, the tool turning portion 31 and adjusting portion 21 are concave and convex complementary, and the tool turning portion 31 may be a U-shaped, cross-shaped, straight-line shaped or polygonal shaped clip mouth. Furthermore, the side plate 3 is provided with an accommodation space 33 for accepting the adjusting portion 21. When the main body 2 is combined with the side plate 3, the adjusting portion 21 can be hidden in the accommodation space 33 of the side plate 3, so that it can be prevented from hurting people, thereby having a safe effect.

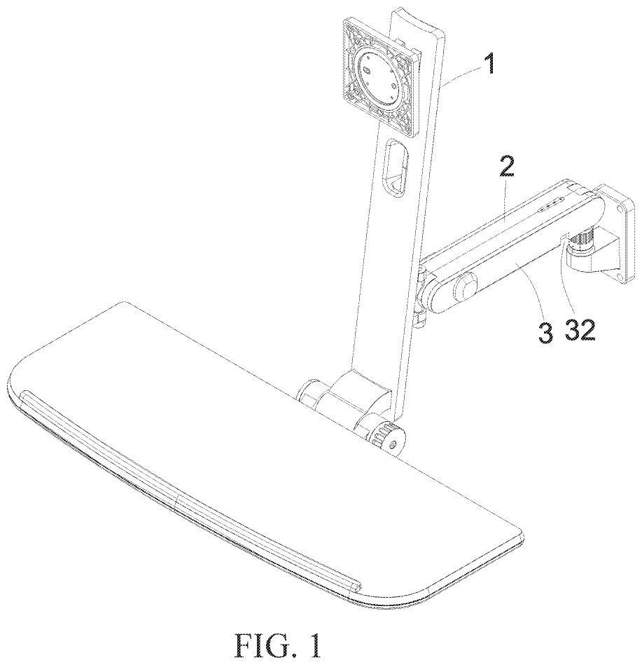

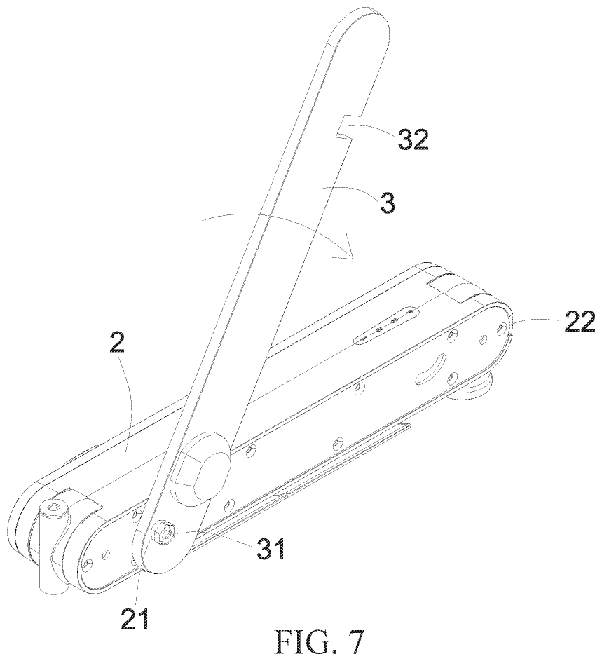

If the torque of the holder 1 wants to be adjusted, only the side plate 3 needs to be taken down from the main body 2, and the tool turning portion 31 is aligned with the adjusting portion 21 and then turns it for the torque adjustment, as FIG. 7 shows, and only the side plate 3 needs to be placed back to the main body 2 after the adjustment is completed, as FIG. 1 shows, so that adjusting portion 21 can be hidden and placed, allowing the side plate 3 to be taken down to use next tune, so that the present invention has a hiding and storage effect.

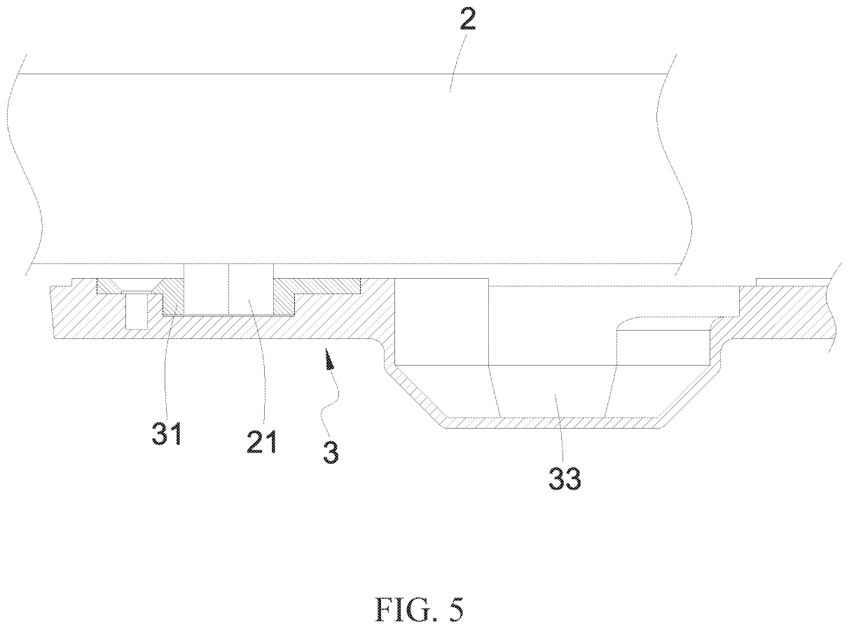

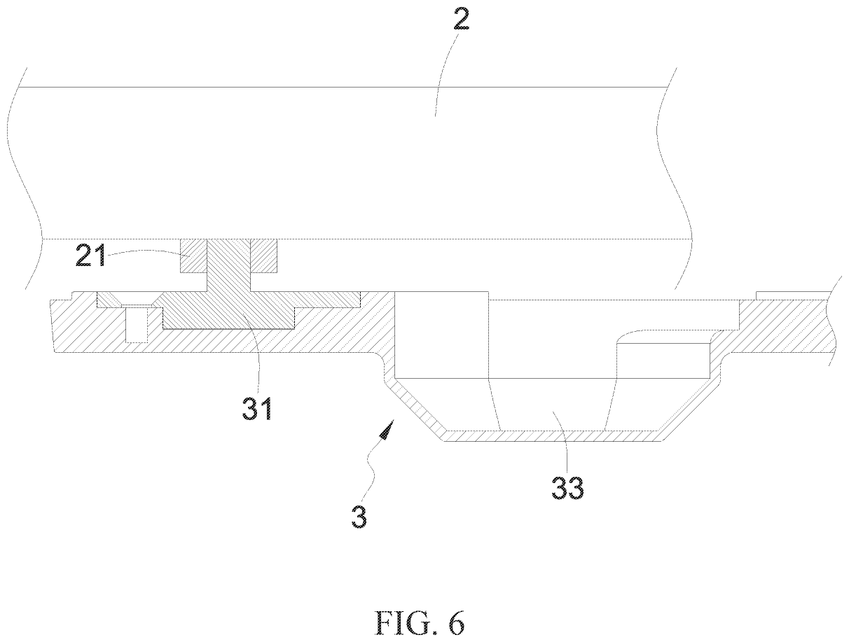

Referring to FIGS. 5 and 6, the adjusting portion 21 and tool turning portion 31 are complementary, i.e., the adjusting portion 21 is convex when the tool turning portion 31 is concave, and if the tool turning portion 31 is convex, the adjusting portion 21 is concave. Preferably, the adjusting portion 21 is a screw or nut.

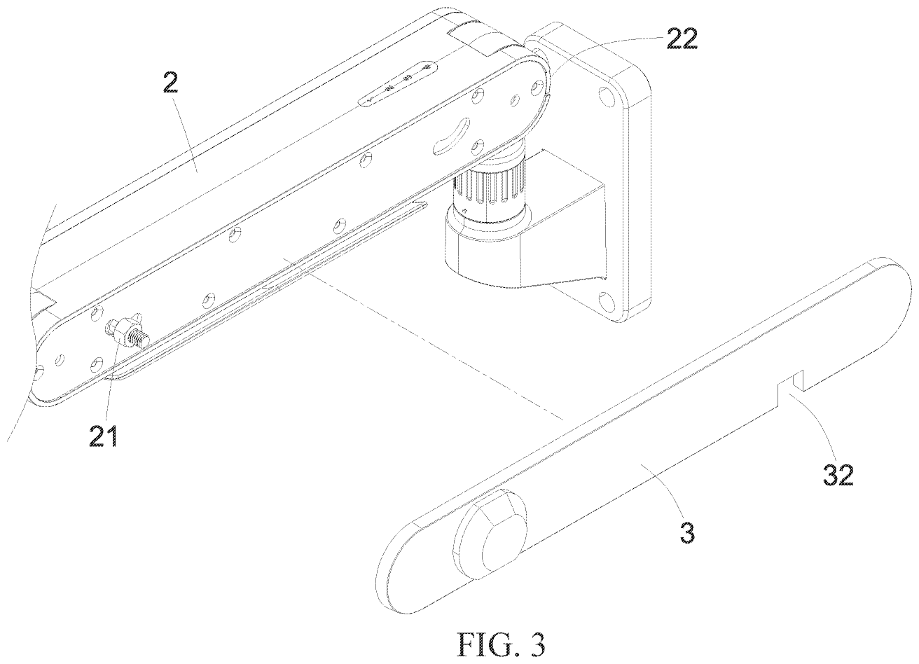

Referring to FIG. 3 again, the main body 2, preferably, is provided with a first concave portion 22 positioned on the connection of the main body 2 and side plate 3, which allows the side plate 3 is more conveniently and easily taken down from the main body 2.

Referring to FIG. 3 again, the side plate 3 is provided with a second concave portion 32 positioned on the connection of the main body 2 and side plate 3, which allows the side plate 3 is more conveniently and easily taken down from the main body 2.

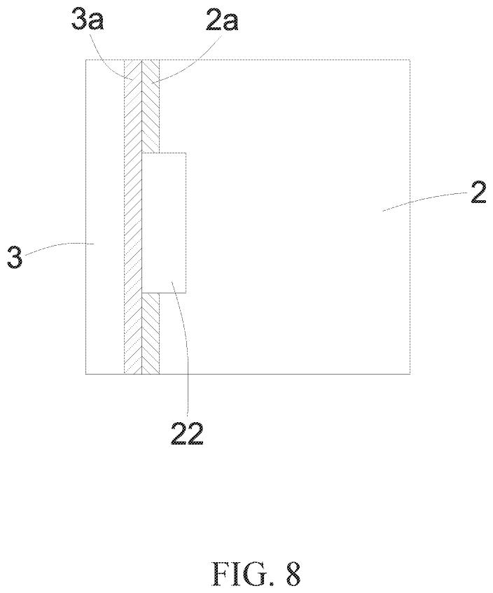

Preferably, the side plate 3 is placed on one side of the main body 2, and the combination thereof may be adsorption, for example, the housing of the main body 2 is provided with a magnetizing layer 2a, and the side plate 3 a magnetized layer 3a, as FIG. 8 shows.

Preferably, the side plate 3 is placed on one side of the main body 2, and the combination thereof may be embedding; the length and width of the side plate 3 are slightly smaller than the ones of the main body 2.

I claim:

1. A hidden tool for an electronic device holder, comprising:
a holder;
a main body, in connection with said holder, and provided with an adjusting portion; and
a side plate, placed on one side of said main body, and provided with a tool turning portion complementary to said adjusting portion.

2. The hidden tool according to claim 1, wherein said tool turning portion is convex or concave, and is a U-shaped, cross-shaped, straight-line shaped or polygonal shaped clip mouth.

3. The hidden tool according to claim 1, wherein said side plate is provided an accommodating space.

4. The hidden tool according to claim 1, wherein said main body is provided with a first concave portion.

5. The hidden tool according to claim 1, wherein said side plate is provided with a second concave portion.
